(19) United States
(12) Patent Application Publication
(10) Pub. No.: US 2008/0021986 A1
(43) Pub. Date: Jan. 24, 2008

(54) APPARATUS AND METHOD FOR MANAGING ENVIRONMENT INFORMATION IN MULTI-PROCESSOR SYSTEM

(75) Inventors: Zea-Jong KANG, Anyang-si (KR); Je-Hun Kim, Suwon-si (KR)

Correspondence Address: Jefferson IP Law, LLP, 1730 M Street, NW, Suite 807, Washington, DC, 20036, US

(73) Assignee: Samsung Electronics Co., LTD., Suwon-city (KR)

(21) Appl. No.: 11/776,717

(22) Filed: Jul. 12, 2007

(30) Foreign Application Priority Data
Jul. 18, 2006 (KR) 10-2006-0066797

(51) Int. Cl. G06F 15/173; G06F 15/177; H04Q 7/24

(52) U.S. Cl. 709/222; 370/338; 709/223

(57) ABSTRACT

A multi-processor system and method are provided. A multi-processor network management apparatus in a broadband wireless communication system includes a main processor and at least one primary sub processor. The main processor controls an overall operation of the multi-processor network management apparatus and provides environment information to other processors. The primary sub processor performs processor initialization using the environment information received from the main processor.

### PRIORITY

This application claims the benefit under 35 U.S.C. § 119(a) to a Korean patent application filed Jul. 18, 2006 in the Korean Intellectual Property Office and assigned Serial No. 2006-0066797, the entire disclosure of which is hereby incorporated by reference.

### BACKGROUND OF THE INVENTION

1. Field of the Invention

The present invention relates generally to a multi-processor system. More particularly, the present invention relates to an apparatus and method for managing environment information of processors in a multi-processor system. The environment information refers to setup information that is fundamentally necessary for an initial operation of each of the processors. Examples of the environment information include a type and address of a device to which the processor belongs, an address of the device that stores a corresponding execution program, and information about a path and protocol for loading the execution program.

2. Description of the Related Art

With the development of modern technologies, data used in a system increases in amount and complexity. A single-processor system may fail to process the large and complex data. Therefore, a multi-processor system is used that can reduce a process load and increase a process speed by distributing a function centralized at one processor of the single-processor system to a plurality of processors.

In the multi-processor system, processors perform their respective functions. That is, each of the processors loads its execution program stored in an external storage and performs its own function according to the loaded execution program. In order to load the execution program, the processor must obtain information about a path for accessing a storage storing the execution program or an address of the storage. That is, the processor must detect the environment information such as the path and the storage address for an initial operation of the system.

In a multi-processor system, the processors store their respective environment information. At a system initialization stage, each of the processors loads the execution program using the stored environment information. However, when the environment information is to be corrected, the information stored in the respective processors must be corrected one by one. This increases the possibility of an error in the environment information and also impedes flexible system design.

### SUMMARY OF THE INVENTION

An aspect of the present invention is to address at least the above problems and/or disadvantages and to provide at least the advantages described below. Accordingly, an aspect of the present invention is to provide an apparatus and method for managing environment information in a multi-processor system in an integrated fashion.

Another aspect of the present invention is to provide an apparatus and method for storing environment information of all processors in a main processor in a multi-processor system.

Still another aspect of the present invention is to provide an apparatus and method for providing sub processors with environment information stored in a main processor in a multi-processor system.

According to an aspect of the present invention, a multi-processor network management apparatus in a broadband wireless communication system is provided. The multi-processor network management apparatus includes a main processor for controlling an overall operation of the multi-processor network management apparatus and for providing environment information to other processors, and at least one primary sub processor for performing processor initialization using the environment information received from the main processor.

According to another aspect of the present invention, a main processor of a multi-processor network management apparatus in a broadband wireless communication system is provided. The main processor of a multi-processor network management apparatus includes an environment information storage for storing environment information of all processors in the multi-processor network management apparatus, and a controller for providing the environment information to sub processors.

According to still another aspect of the present invention, a sub processor of a multi-processor network management apparatus in a broadband wireless communication system is provided. The sub processor of a multi-processor network management apparatus includes a location information storage for storing location information of the sub processor with respect to inter-processor connection structure, and a controller for identifying itself as a sub processor on the basis of the location information at a processor initialization stage and for receiving environment information from an upper processor.

According to even another aspect of the present invention, a method for operating a main processor of a multi-processor network management apparatus in a broadband wireless communication system is provided. The method includes determining if an environment information request signal is received from sub processors in the multi-processor network management apparatus, and providing the environment information to the sub processors.

According to yet another aspect of the present invention, a method for operating a sub processor of a multi-processor network management apparatus in a broadband wireless communication system is provided. The method includes detecting that the sub processor is not a main processor on the basis of location information at a processor initialization stage, and receiving environment information from an upper processor in the multi-processor network management apparatus.

### BRIEF DESCRIPTION OF THE DRAWINGS

The above and other aspects, features and advantages of certain exemplary embodiments of the present invention will become more apparent from the following detailed description when taken in conjunction with the accompanying drawings in which:

FIG. 1 is a block diagram of a multi-processor system according to an exemplary embodiment of the present invention;

FIG. 2 is a flowchart illustrating a procedure for providing environment information from a main processor in a multi-processor system according to an exemplary embodiment of the present invention;

FIG. 3 is a flowchart illustrating a procedure for receiving environment information at a sub processor in a multi-processor system according to an exemplary embodiment of the present invention;

FIG. 4 is a flow diagram illustrating a procedure for inter-processor signal exchange in a multi-processor system according to an exemplary embodiment of the present invention; and

FIG. 5 is a diagram illustrating an inter-processor connection structure in a multi-processor system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of the exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions will be omitted for clarity and conciseness.

The present invention provides an apparatus and method for managing environment information of each processor, which is necessary for an initial system operation, at a main processor in a multi-processor system. The present invention also provides an apparatus and method for providing the environment information from the main processor to sub processors.

The present invention, which will be described below, can be applied to a multi-processor network management apparatus in a broadband wireless communication system. An example of the network management apparatus is a base station that communicates with user terminals over wireless channels or a control station that functions as a router of a subnet including base stations. In this case, the environment information includes at least one of an identifier of a network management apparatus to which a processor belongs, a type of a network management apparatus, an Internet protocol (IP) address of a system management server, a type of a link connected to a core network, an IP address of each link connected to the core network, a media access control (MAC) address for a debug link, the use or not of a gateway for connection to the core network, an IP address of the gateway, and an IP address for transmission of a message resulting from the occurrence of an event.

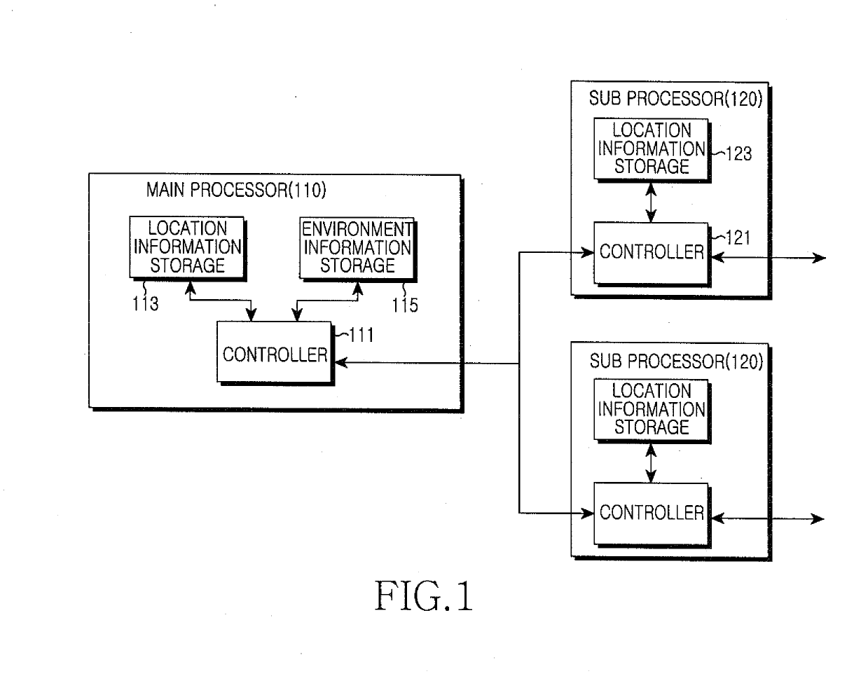

FIG. 1 is a block diagram of a multi-processor system according to an exemplary embodiment of the present invention.

Referring to FIG. 1, the multi-processor system includes a main processor 110 and sub processors 120.

The main processor 110 includes a controller 111, a location information storage 113, and an environment information storage 115.

The controller 111 controls an overall operation of the main processor 110. According to an exemplary embodiment of the present invention, the controller 111 controls a function for providing environment information stored in the environment information storage 115 to the sub processors 120 at a system initialization stage.

The location information storage 113 stores information about where the main processor 110 is located in a processor connection structure. That is, the location information storage 113 stores information for the main processor 110 to identify itself as a main processor.

The environment information storage 115 stores environment information of all the processors in the multi-processor system. The environment information storage 115 may be constructed using a nonvolatile memory. Therefore, data stored in the environment information storage 115 may be retained even when the system is powered off. The environment information storage 115 provides the environment information to the controller 111 at the system initialization stage.

The sub processor 120 includes a controller 121 and a location information storage 123.

The controller 121 controls an overall operation of the sub processor 120. According to an exemplary embodiment of the present invention, the controller 121 controls a function for receiving environment information from an upper processor (i.e., the main processor 110) at the system initialization stage. In addition, if there is a lower sub processor subordinate to the sub processor 120, the controller 121 controls a function for providing environment information of the lower sub processor, which has been received from the main processor 110, to the lower sub processor.

The location information storage 123 stores information about where the sub processor 120 is located in the processor connection structure. That is, the location information storage 123 stores information for the sub processor 120 to identify itself as a sub processor.

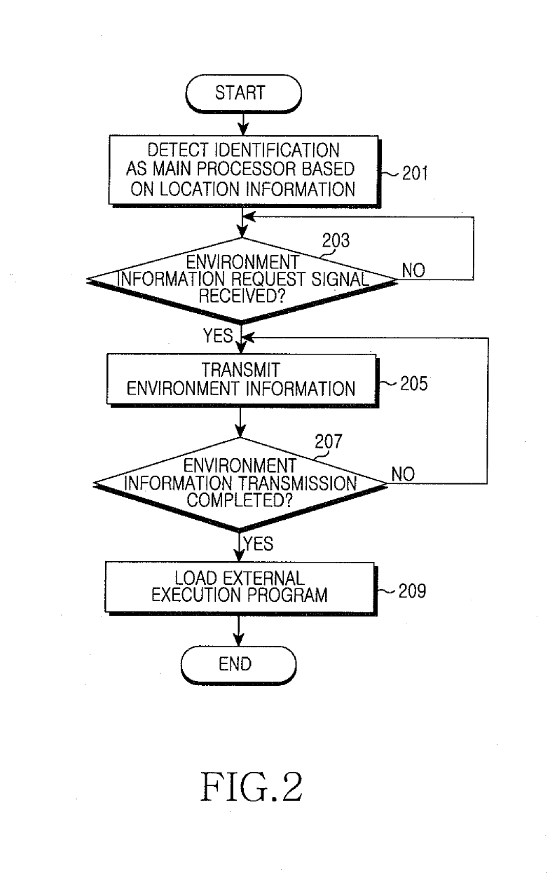

FIG. 2 is a flowchart illustrating a procedure for providing environment information from the main processor 110 in a multi-processor system according to an exemplary embodiment of the present invention.

Referring to FIG. 2, in step 201, the controller 111 detects that its processor is the main processor 110 based on location information stored in the processor at the system initialization stage. That is, because the main processor 110 must provide environment information to the sub processor, the main processor 110 waits to receive an environment information request signal from the sub processor.

In step 203, the controller 111 determines if an environment information request signal is received from the sub processor. If so, the procedure proceeds to step 205.

In step 205, the controller 111 transmits the corresponding environment information to the sub processor.

In step 207, the controller 111 determines if transmission of environment information to all the sub processors connected directly to the main processor 110 is completed. If so, the procedure proceeds to step 209. In contrast, if not completed, the controller 111 returns to step 205.

In step 209, the controller 111 loads an external execution program. Thereafter, the procedure is ended.

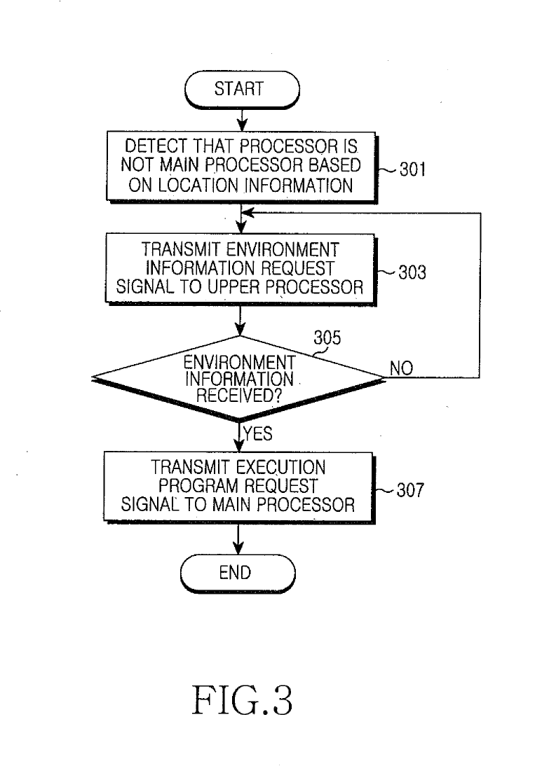

FIG. 3 is a flowchart illustrating a procedure for receiving environment information at the sub processor 120 in the multi-processor system according to an exemplary embodiment of the present invention.

Referring to FIG. 3, in step 301, the controller 121 detects that its processor is not the main processor 110 based on the location information stored in the processor at the system initialization stage. That is, the controller 121 detects that environment information is not stored in the processor.

In step 303, the controller 121 transmits an environment information request signal to an upper processor (i.e., the main processor 110).

In step 305, the controller 121 determines if environment information is received from the upper processor within a predetermined time. If so, the procedure proceeds to step 307, and if not, the procedure returns to step 303.

In step 307, the controller 121 transmits an execution program request signal to the main processor 110.

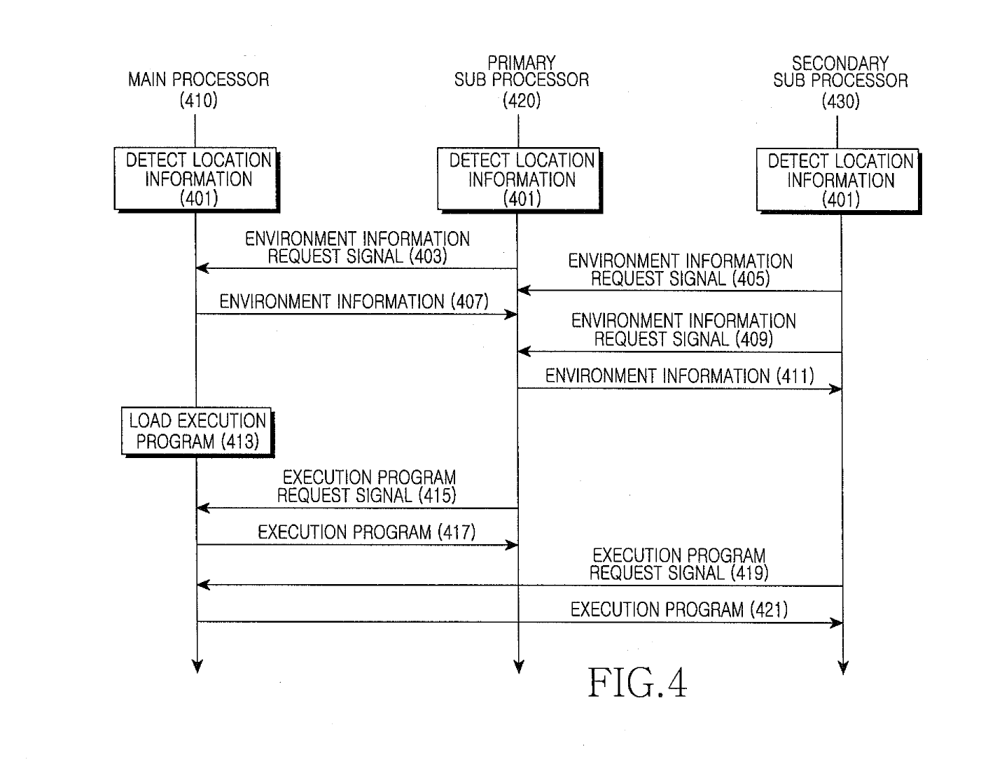

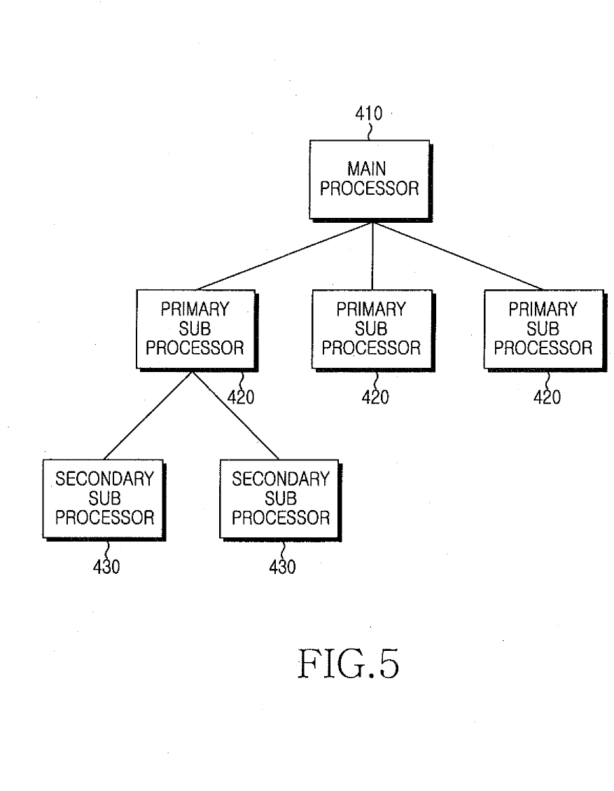

FIG. 4 is a flow diagram illustrating a procedure for inter-processor signal exchange in a multi-processor system according to an exemplary embodiment of the present invention. FIG. 5 is a diagram illustrating an inter-processor connection structure in the multi-processor system of FIG. 4 according to an exemplary embodiment of the present invention. Referring to FIGS. 4 and 5, a main processor 410 manages an overall operation of a multi-processor system (e.g., a base station or a control station), performs system execution program downloading, configuration information management, and trouble/status management, and serves as a final statistics collector. A primary sub processor 420 and a secondary sub processor 430 share some functions for an operation of a multi-processor system (e.g., a base station or a control station). The primary sub processor 420 receives environment information directly from the main processor 410, while the secondary sub processor 430 receives environment information through the primary sub processor 420.

Referring to FIG. 4, the main processor 410, the primary sub processor 420, and the secondary sub processor 430 detect their location information at a system initialization stage in step 401. The main processor 410 identifies itself as a main processor and waits to receive an environment information request signal, while each of the primary and secondary sub processors 420 and 430 detects that it is not a main processor and transmits an environment information request signal to an upper processor in steps 403 and 405.

That is, the primary sub processor 420 detects that it is not a main processor and transmits an environment information request signal to the main processor 410 in step 403. Likewise, the secondary sub processor 430 detects that it is not a main processor and transmits an environment information request signal to the primary sub processor 420 in step 405.

Upon receipt of the environment information request signal from the primary sub processor 420, the main processor 410 transmits environment information to the primary sub processor 420 in step 407. At this point, the environment information includes not only environment information of the primary sub processor 420 but also environment information of all processors subordinate to the primary sub processor 420.

If the secondary sub processor 430 fails to receive environment information within a predetermined time after transmission of the environment information request signal, it retransmits another environment information request signal to the primary sub processor 420 step 409.

Upon receipt of the environment information request signal from the secondary sub processor 430, the primary sub processor 420 transmits the environment information of the secondary sub processor 430, which has been received from the main processor 410, to the secondary sub processor 430 in step 411.

Upon completion of transmission of the environment information to the primary sub processor 420, the main processor 410 loads an execution program from an external server in step 413.

Upon receipt of the environment information, the primary sub processor 420 transmits an execution program request signal to the main processor 410 in step 415.

Upon receipt of the execution program request signal from the primary sub processor 420, the main processor 410 transmits the execution program to the primary sub processor 420 in step 417.

Upon receipt of the environment information, the secondary sub processor 430 transmits an execution program request signal to the main processor 410 in step 419.

Upon receipt of the execution program request signal from the secondary sub processor 430, the main processor 410 transmits the execution program to the secondary sub processor 430 in step 421.

In an exemplary embodiment, the main processor provides the environment information to all the sub processors at the system initialization stage and then loads the execution program. In an exemplary embodiment, the main processor provides the environment information to only the sub processor related to the execution program loading path, loads the execution program, and then provides the environment information to the remaining sub processors.

There may be a case where the sub processor is independently initialized after the system initialization stage. Therefore, the main processor provides the environment information to the corresponding sub processor every time when it receives an environment information request signal, as well as at the system initialization stage.

As described above, the main processor manages the environment information of all the processors in the multi-processor system, thereby making it possible to simplify the system operation and to provide flexibility for various structures.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A multi-processor network management apparatus in a wireless communication system, the multi-processor network management apparatus comprising:
a main processor for controlling an overall operation of the multi-processor network management apparatus and for providing environment information to other processors; and
at least one primary sub processor for performing processor initialization by using the environment information received from the main processor.

2. The multi-processor network management apparatus of claim 1, wherein the multi-processor network management apparatus comprises a base station that communicates with user terminals over wireless channels or a control station that functions as a router of a subnet including base stations.

3. The multi-processor network management apparatus of claim 1, wherein the environment information comprises at least one of an identifier of the multi-processor network management apparatus, a type of the multi-processor network management apparatus, an Internet protocol (IP) address of a system management server, a type of a link connected to a core network, an IP address of each link connected to the core network, a media access control (MAC) address for a debug link, the use or not of a gateway for connection to the core network, an IP address of the gateway, and an IP address for transmission of a message resulting from the occurrence of an event.

4. The multi-processor network management apparatus of claim 1, wherein the main processor provides the environment information to the primary sub processor upon receipt of an environment information request signal from the primary sub processor.

5. The multi-processor network management apparatus of claim 1, wherein the main processor identifies itself as a main processor by detecting location information stored therein.

6. The multi-processor network management apparatus of claim 1, wherein the primary sub processor identifies itself as a sub processor by detecting location information stored therein.

7. The multi-processor network management apparatus of claim 6, wherein the primary sub processor transmits an environment information request signal to the main processor after the identification as a sub processor at a processor initialization stage.

8. The multi-processor network management apparatus of claim 1, further comprising at least one secondary sub processor that receives environment information from the primary sub processor.

9. A main processor of a multi-processor network management apparatus in a wireless communication system, the main processor comprising:
an environment information storage for storing environment information of all processors in the multi-processor network management apparatus; and
a controller for providing the environment information to sub processors.

10. The main processor of claim 9, wherein the environment information comprises at least one of an identifier of the multi-processor network management apparatus, a type of the multi-processor network management apparatus, an Internet protocol (IP) address of a system management server, a type of a link connected to a core network, an IP address of each link connected to the core network, a media access control (MAC) address for a debug link, the use or not of a gateway for connection to the core network, an IP address of the gateway, and an IP address for transmission of a message resulting from the occurrence of an event.

11. The main processor of claim 9, wherein the controller provides the corresponding environment information to the sub processor upon receipt of an environment information request signal from the sub processor.

12. The main processor of claim 9, further comprising a location information storage for storing location information of the main processor with respect to an inter-processor connection structure, wherein the controller identifies itself as a main processor on the basis of the location information.

13. The main processor of claim 9, wherein the multi-processor network management apparatus comprises a base station that communicates with user terminals over wireless channels or a control station that functions as a router of a subnet including base stations.

14. A sub processor of a multi-processor network management apparatus in a wireless communication system, the sub processor comprising:
a location information storage for storing location information of the sub processor with respect to an inter-processor connection structure; and
a controller for identifying itself as a sub processor on the basis of the location information at a processor initialization stage and for receiving environment information from an upper processor.

15. The sub processor of claim 14, wherein the environment information comprises at least one of an identifier of the multi-processor network management apparatus, a type of the multi-processor network management apparatus, an Internet protocol (IP) address of a system management server, a type of a link connected to a core network, an IP address of each link connected to the core network, a media access control (MAC) address for a debug link, the use or not of a gateway for connection to the core network, an IP address of the gateway, and an IP address for transmission of a message resulting from the occurrence of an event.

16. The sub processor of claim 14, wherein upon receipt of an environment information request signal from a lower sub processor subordinate to the sub processor, the controller provides the corresponding environment information to the lower sub processor.

17. The sub processor of claim 14, wherein the multi-processor network management apparatus comprises a base station that communicates with user terminals over wireless channels or a control station that functions as a router of a subnet including base stations.

18. A method for operating a main processor of a multi-processor network management apparatus in a wireless communication system, the method comprising:
determining if an environment information request signal is received from sub processors in the multi-processor network management apparatus; and
providing the environment information to the sub processors.

19. The method of claim 18, wherein the environment information comprises at least one of an identifier of the multi-processor network management apparatus, a type of the multi-processor network management apparatus, an Internet protocol (IP) address of a system management server, a type of a link connected to a core network, an IP address of each link connected to the core network, a media access control (MAC) address for a debug link, the use or not of a gateway for connection to the core network, an IP address of the gateway, and an IP address for transmission of a message resulting from the occurrence of an event.

20. The method of claim 18, further comprising identifying itself as the main processor based on prestored location information.

21. The method of claim 18, wherein the multi-processor network management apparatus comprises a base station that communicates with user terminals over wireless channels or a control station that functions as a router of a subnet including base stations.

22. A method for operating a sub processor of a multi-processor network management apparatus in a wireless communication system, the method comprising:
detecting that the sub processor is not a main processor on the basis of location information at a processor initialization stage; and
receiving environment information from an upper processor in the multi-processor network management apparatus.

23. The method of claim 22, wherein the environment information comprises at least one of an identifier of the multi-processor network management apparatus, a type of the multi-processor network management apparatus, an Internet protocol (IP) address of a system management server, a type of a link connected to a core network, an IP address of each link connected to the core network, a media access control (MAC) address for a debug link, the use or not of a gateway for connection to the core network, an IP address of the gateway, and an IP address for transmission of a message resulting from the occurrence of an event.

24. The method of claim 22, further comprising:
determining if an environment information request signal is received from a lower sub processor subordinate to the sub processor; and
providing the corresponding environment information to the lower sub processor.

25. The method of claim 22, wherein the multi-processor network management apparatus comprises a base station that communicates with user terminals over wireless channels or a control station that functions as a router of a subnet including base stations. _
